(19) United States
(12) Patent Application Publication
(10) Pub. No.: US 2017/0275563 A1
(43) Pub. Date: Sep. 28, 2017

(54) EFFERVESCENT COMPOSITIONS AND METHODS OF MAKING SAME

(71) Applicants: Michael C. FEDERLE, Cincinnati, OH (US); Federle CPG, LLC, Cincinnati, OH (US)

(72) Inventor: MICHAEL C. FEDERLE, Cincinnati, OH (US)

(21) Appl. No.: 15/504,908

(22) PCT Filed: Sep. 3, 2015
(86) PCT No.: PCT/US15/48317

§ 371 Date: Feb. 17, 2017

Related U.S. Application Data
(60) Provisional application No. 62/045,081, filed on Sep. 3, 2014.

(51) Int. Cl. C11D 3/00; C11D 3/43; C11D 3/386; C11D 17/00; C11D 3/50; C11D 3/40; C11D 3/48; C11D 17/04; C11D 3/20; C11D 3/39

(52) U.S. Cl. CPC C11D 3/0052; C11D 3/2093; C11D 3/43; C11D 3/38636; C11D 3/3942; C11D 3/50; C11D 3/40; C11D 3/48; C11D 17/042; C11D 17/0047; C11D 3/0068; C12Y 111/01006

(57) ABSTRACT

Effervescent compositions are disclosed, particularly effervescent compositions useful in toilet bowls. The effervescent composition may include at least one liquid or solid hydrogen peroxide source and at least one catalyst capable of catalyzing an oxidation of the hydrogen peroxide source in the presence of a liquid, such as water. Accordingly, the effervescent composition is capable of effervescence in the presence of a liquid. The effervescent composition may also include a non-hygroscopic solvent. The presence of the non-hygroscopic solvent may assist the effervescent composition in substantially avoiding effervescence until the composition contacts the liquid. Optionally, the ratio of the hydrogen peroxide source and catalyst to the non-hygroscopic solvent is not less than 9:1.

### CROSS-REFERENCE TO RELATED APPLICATION

This application claims priority to U.S. Provisional Patent Application No. 62/045,081, entitled NOVEL EFFERVESCENT COMPOSITIONS AND METHODS OF MAKING SAME, filed Sep. 3, 2014, the contents of which are hereby incorporated by reference in their entirety.

### FIELD OF THE INVENTION

This invention relates generally to effervescent compositions, and more particularly to effervescent compositions useful in toilets.

### BACKGROUND OF THE INVENTION

According to the World Toilet Organization (WTO), a person flushes the toilet 6-8 times per day. Due to this repetitive and important action in consumers' daily life, products have been developed to support a more pleasurable and utilitarian response to this consumer habit. Examples of these products include, but are not limited to, scented toilet paper, acute/chronic air fresheners, and toilet bowl/tank cleaning tablets.

A vital part of a product cycle in the consumer packaged goods (CPG) industry that has been perfected by mature CPG firms is a concept called “sustainable” and “disruptive” innovation. The consumer is provided with products iteratively improved as to cost and/or performance, thus preventing premium branded products from being commoditized by competing organizations. Indeed, “disruptive” substrate technologies have been developed for the delivery of fragrance and/or cleaning/disinfectants/chelating agents directly into toilet bowls.

Previous such technologies include an effervescent component that operates through an acid/base reaction, resulting in the release of carbon dioxide gas. However, these effervescent components react with moisture in the air to form a byproduct crust on the outside of the product, which are often in tablet form, when exposed over time. Because this product is meant to be placed in a prominent location of a confined bathroom setting, where water enters the air from the sink/toilet/shower/etc., such a byproduct crust is not desired. The present invention addresses the aforementioned.

### SUMMARY OF THE INVENTION

Effervescent compositions and methods for using and making effervescent compositions are disclosed.

In one embodiment, the effervescent composition of the present invention is capable of being inserted into a liquid, such as the water contained within a toilet bowl or tank. The effervescent composition includes at least one solid or liquid hydrogen peroxide source and at least one catalyst capable of catalyzing the oxidation of hydrogen peroxide source to form dioxygen. The effervescent composition further can include a non-hygroscopic solvent. The effervescent composition is capable of effervescence upon contact with the liquid, with the effervescence being substantially avoided until the composition contacts such liquid.

In another embodiment, a method for controlling effervescence in a liquid environment includes adding to the liquid environment an effervescent composition including at least one solid or liquid hydrogen peroxide source and at least one catalyst capable of catalyzing the oxidation of hydrogen peroxide source to form dioxygen. The effervescent composition further can include a non-hygroscopic solvent. The composition is capable of effervescence upon contact with a liquid, such as the water contained within a toilet bowl. The effervescent composition also substantially avoids effervescence until the composition contacts such liquid.

In yet another embodiment, a method for making an effervescent composition is provided. The method includes mixing at least solid or liquid hydrogen peroxide source and at least one catalyst capable of catalyzing the oxidation of the hydrogen peroxide source. The method further includes combining the mixture with a non-hygroscopic solvent, which may be selected from the group consisting of diethyl phthalate, isopropyl myristate, isopropyl palmitate, dioctyl adipate, and butyl stearate. The effervescent composition is capable of effervescence upon contact with a liquid and substantially avoids effervescence caused by the formation of dioxygen until the effervescent composition contacts such liquid.

### DETAILED DESCRIPTION

Unless clearly defined otherwise from the context, any range of values presented in the following Detailed Description and Claims includes each end point as well as each whole number or fractional part thereof, within the recited range. Additionally, approximating language may be applied to modify any quantitative representation that may vary without resulting in a change in the basic function to which it is related. Accordingly, a value modified by a term or terms, such as “about” and “substantially,” may not be limited to the precise value specified.

The effervescent composition of the present invention includes at least one hydrogen peroxide source and at least one catalyst, which are, together, capable of effervescence, and a non-hygroscopic solvent. The effervescent composition may optionally include other components. Regardless of the inclusion of these other components, however, the term “effervescent,” as defined herein, means any product capable of forming bubbles in a liquid, such as toilet water, and may also be considered any product capable of liberating dioxygen in or out of the liquid. Likewise, “effervescence” means forming bubbles in liquids or liberating dioxygen in or out of liquids.

In certain embodiments, the presence of bubbles results from the formation of dioxygen (i.e., molecular oxygen, O₂). For instance, when added to a liquid, e.g., added to or immersed in water, such as toilet water, a mixture of one or more hydrogen peroxides and one or more catalysts results in a reaction that liberates dioxygen. In one aspect, both the hydrogen peroxide source and the catalyst may be in anhydrous and liquid form.

Examples of hydrogen peroxide sources include liquid hydrogen peroxide and solid sources. Solid sources, for example, include urea peroxide, carbamide peroxide, and inorganic perhydrate salts, including alkali metal salts such as sodium salts of perborate (usually mono- or tetra-hydrate), percarbonate, persulphate, perphosphate, persilicate salts, or mixtures thereof. In one aspect of the invention the organic and inorganic perhydrate salts are selected from sodium salts of perborate, percarbonate, or mixtures thereof.

In some embodiments, the catalyst may be the biological enzyme catalase, manganese dioxide, sodium iodide, or potassium iodide. The catalyst catalyzes the reaction from hydrogen peroxide to oxygen and water. Manganese dioxide, sodium iodide, and potassium iodide may not be favored for this application, since it may leave a dark residue. Manganese dioxide, sodium iodide, or potassium iodide may be used if the user is less concerned about the dark residue.

In other embodiments, the selection of a specific hydrogen peroxide and catalyst and their proportions depend, at least in part, upon the requirements for the amount of dioxygen release. In some embodiments, the catalyst may be added in an amount of about 1% to about 20% by weight of the effervescent composition, while the hydrogen peroxide source may also be added in an amount of about 10% to 99.9% by weight of the effervescent composition. In another example, the catalyst may be added in an amount of about 1% to about 15% by weight of the effervescent composition. And in another example, the hydrogen peroxide source may be added in an amount of about 70% to 90% by weight of the effervescent composition.

The effervescent composition of the present invention also includes a non-hygroscopic solvent, which in select embodiments, may be added to the effervescent composition in an amount of up to 10% by weight of the effervescent composition. Thus, the hydrogen peroxide source/catalyst component of these embodiments can include 90% or more of the final formulation, and the ratio of the hydrogen peroxide source/catalyst component to the non-hygroscopic solvent can be about 9:1 or more. If the ratio of the peroxide source/catalyst component to the non-hygroscopic solvent falls below 9:1, the final formulation may form a sticky mixture or slurry.

The term non-hygroscopic solvent is defined herein as any compound that does not take up moisture from the environment. Since neither the effervescent composition nor the non-hygroscopic solvent itself absorbs moisture, the formation of bubbles should be substantially avoided until the effervescent composition is contacted by a liquid, such as when immersed in toilet water. That is, moisture from the environment should not precipitate a premature reaction between the hydrogen peroxide source/catalyst of the effervescent composition, before these chemical constituents come into direct contact with liquids, e.g., toilet water. Accordingly, substantially avoiding effervescence prior to contact with a liquid preserves the desired function of the effervescent composition. As used herein, “substantial” and “substantially” mean being mostly, but not necessarily wholly, that which is specified. In this context, a small amount of effervescence may be present prior to contacting with a liquid as long as the desired function of the effervescent composition is mostly preserved.

In some embodiments, the non-hygroscopic solvent is capable of dissolving or dispersing at least a small amount of one or more other substances. Such non-hygroscopic solvents include, but are not limited to diethyl phthalate, isopropyl myristate, isopropyl palmitate, and at least some species of ester solvents, such as dioctyl adipate or butyl stearate.

In other embodiments, the non-hygroscopic solvent may be non-aqueous or non-polar (aprotic). With respect to the non-aqueous aspect, the absence of water from the effervescent composition substantially avoids the formation of bubbles until the effervescent composition is contacted by a liquid. Regarding the absence of polarity, this feature avoids dissociation of the hydrogen peroxide source of the effervescent composition, which under certain circumstances may trigger a premature reaction between the hydrogen peroxide source/catalyst components of the effervescent composition.

In still other embodiments, the effervescent composition further includes a fragrance and/or perfume. In these embodiments, the fragrance may be released into the atmosphere through the formation of dioxygen. In one embodiment the fragrance may be present in an amount of up to about 40% by weight of the effervescent composition. In another embodiment the fragrance may be present in an amount of up to about 6% by weight of the effervescent composition.

Often, but not always, the fragrance contains the non-hygroscopic solvent. In these embodiments, the non-hygroscopic solvent may be present in an amount of up to 25% by weight of the fragrance or up to 1.5% by weight of the effervescent composition.

Fragrances typically, but not always, include highly concentrated solid ingredients. The presence of the non-hygroscopic solvent may be necessary to dissolve, disperse, or mix these solid ingredients to make the fragrance homogenous throughout the effervescent composition. Because fragrance manufacturers often incorporate solvents directly into their fragrances, coordinating solvent selection with the fragrance manufacturer may be necessary.

The effervescent composition may further include a colorant. The colorant may be oil- or water-soluble, and may be an anhydrous powder dye. The amount of colorant to be used may depend on the color intensity desired and the cost of the dye, and may be added at levels up to about 2.5% by weight of the effervescent composition.

The choice of the colorant will depend largely on the color desired for the liquid, e.g., water, into which the effervescent composition is to be dispensed. Examples of suitable water-soluble colorants include, but are not limited to, acid blue # 9, Basacid Blue NB 755®, FD&C yellow #5, FD&C Red #33, and D&C Green #8. Oil-soluble colorants include, but are not limited to, Nitro Fast Red A 4B®, solvent yellow 72, and Sandoplast Green G®.

In addition, in certain embodiments, the effervescent composition may further include a disinfectant. A disinfectant is any substance capable of destroying or inhibiting the growth of micro-organisms. The disinfectant typically, but not always, may be added in anhydrous form. In some embodiments, the disinfectant may be added to the effervescent composition at levels ranging from about 0.1% to about 10% by weight of the effervescent composition. Examples of suitable disinfectants include, but are not limited to, quaternary ammonium, phenolic, iodophor, inorganic/organic acids, peroxygen, and chlorine-releasing compounds.

In addition, in certain embodiments, the effervescent composition may further include chelating agents. A chelating agent is any substance designed with the purpose of binding an ion into a larger molecule, usually in a liquid state. Chelating agents typically, but not always, may be added in anhydrous form. In some embodiments, the chelating agents may be added to the effervescent composition at levels ranging from about 0.1% to about 10% by weight of the effervescent composition. Examples of suitable chelating agents include, but are not limited to, ethylenediamine tetra acetic acid (EDTA), nitrilotriacetic acid (NTA), and citric acid.

In addition, the effervescent composition may further include a surfactant. A surfactant is any substance capable of reducing surface tension, no matter how slight, between phases. Similar to the colorant, the surfactant may be added in anhydrous form. In some embodiments, the surfactant may be added to the effervescent composition at levels ranging from about 0.25% to about 10% by weight of the effervescent composition. In other embodiments, the surfactant imparts a detergent effect to the effervescent composition.

Surfactants useful in the effervescent composition of the present invention include anionic, non-ionic, cationic, amphoteric, and zwitterionic surfactants. Anionic surfactants are particularly useful because such surfactants are capable of forming a thick foam or lather during liberation of dioxygen by the effervescent composition.

The identity of the surfactant is not particularly limited. Examples of suitable surfactants include, but are not limited to, salts of lauryl sulfonate, salts of alpha olefin sulfonate, alkyl benzene sulfonate, salts of dodecyl benzene sulphonate, and cocoyl glutamic acid. Other types of surfactants include alkyl benzene sulfonates, alkyl ether sulfates, paraffin, sulfonates, olefin sulfonates, amine oxides, alkyl betaines, and the like. Examples of commercial sources of suitable types of surfactants may be found in McCutcheon's Emulsifiers and Detergents, North American Edition, 1987, McCutcheon Division, (MC Publishing Company).

An absorbing agent may also be added to the effervescent composition of the present invention, in an amount of about 0.1% to about 10% by weight of the effervescent composition. The absorbing agent is useful for taking up moisture that may come into contact with the effervescent composition, thereby preventing a premature reaction between the hydrogen peroxide source/catalyst of the effervescent composition.

The absorbing agent is typically a compound comprising silica (silicon dioxide). Examples of such absorbing agents include, but are not limited to, amorphous silica, foamed silica, and synthetic silica.

In other aspects, the invention involves methods of making the effervescent composition described herein. In illustrative embodiments, the effervescent composition may be prepared in a V-blender or a ribbon blender.

If a V-blender is employed, in one embodiment, a hydrogen peroxide source may be pre-mixed with a non-hygroscopic solvent, and then poured into to the blender. Addition of catalyst to the blender follows. Mixing of the compounds for approximately fifteen minutes occurs. In another embodiment, a fragrance containing a non-hygroscopic solvent and a hydrogen peroxide source are pre-mixed, and then added to the V-blender. A surfactant may then be added to the blender, followed by mixing until substantially homogeneous. The catalyst, a flowing agent, and a dye may be added next, with additional mixing until substantially homogeneous.

A ribbon blender may also be employed. This processing method is faster and more efficient than the embodiment described above using the V-blender. In embodiments using a ribbon blender, the chemical constituents may be added simultaneously, followed by mixing. Alternatively, a fragrance containing a non-hygroscopic solvent may be sprayed into the ribbon blender during the mixing process.

Regardless of the type of blender employed, external conditions, such as temperature and humidity, should be monitored throughout the process of making the effervescent composition. Ideally, manufacture of the effervescent composition is carried out at temperatures between about 20° C. and about 30° C. and at lower relative humidities, up to 40% for example.

Typically, the above-described method of making yields the effervescent composition of the present invention in powder form. The effervescent composition may, however, be supplied in various other forms, such as tablet form, block form, cake form, capsule form, and any other form known to those of skill in the art. To make tablet, block, or cake forms, the powder form may be compressed by methods known to those of skill in the art. Size and hardness are dependent on the mold size and pressure used during the compression process. If a liquid form is desired, in some cases it is necessary to employ a dual bottle with two compartments to separate hydrogen peroxide source/catalyst.

In other embodiments, the effervescent composition of the present invention is capable of being inserted into all toilets, e.g., the toilet bowl or tank, either before or after use, to sanitize or control odors. This includes toilets found in all settings with and without water holding tanks. The invention may also be used to sanitize or control odor in waste water systems.

Odor control may be achieved through certain embodiments of the present invention, and in one aspect, is related to the formation of dioxygen gas. That is, some malodorous compounds have high molecular weights and, therefore, cannot rise to the surface of an aqueous environment to escape into the atmosphere before dioxygen can escape. Thus, in embodiments of the present invention that emit dioxygen, odors with high molecular weights are suppressed. Other malodorous compounds have low molecular weights and escape out of an aqueous environment and into the atmosphere before dioxygen can escape. Malodorous compounds with low molecular weights may also be controlled by the present invention through embodiments that include a fragrance. The presence of the fragrance helps mask malodors as they rise to the surface of the toilet water and after they are released into the environment.

In other embodiments, the various forms of the effervescent composition may be contained in a reagent vessel. A reagent vessel is capable of containing or holding the effervescent composition of the present invention. For example, the reagent vessel may be a sealed pouch, dissolvable in water. In such embodiments, the reagent vessel may be constructed from a permeable filter paper-like material (e.g. the material used in tea bags). This type of material permits the components to leave the reagent vessel after insertion into the toilet so that the components may react in the toilet water.

The reagent vessel may also be constructed of foil, plastic, or any other type of material that will hold the effervescent composition before insertion into a toilet. Such materials include, but are not limited to polyethylene, polypropylene, polystyrene, and polyethylene-terephthalate. In these embodiments, the reagent vessel may be discarded prior to insertion of the effervescent composition into the toilet. For instance, the various forms of the effervescent composition may be packaged in a single use package, which may be carried in one's purse or pocket. When using a public restroom or a friend's bathroom, the user may open the package containing the effervescent composition of the present invention, and dispense the contents into the toilet.

When the effervescent composition of the present invention is contained within a reagent vessel, it is particularly useful to substantially avoid bubbling by the effervescent composition until it contacts a liquid. More specifically, when bubbling results in dioxygen formation, the presence of dioxygen gas may exert pressure on the reagent vessel causing it to rupture and prematurely release its contents before being inserted into a toilet.

In still other embodiments, a dispensing apparatus for delivering the effervescent composition of the present invention into a toilet may be employed. The dispensing apparatus may, for example, be attached to any solid surface on or above a toilet and may include a container connected to a tube or other device for delivering the effervescent composition from the container into the toilet bowl or tank. The dispensing apparatus may be operated by depressing a button or any other suitable means that will dispense appropriate amounts of effervescent composition.

The present invention is illustrated, but in no way limited by the following examples, in which added constituents are reflected in terms of % addition, with the unaccounted-for remainder comprising inert ingredients:

### EXAMPLES 1a-b

Ex. 1a: 80.0% sodium percarbonate may be pre-mixed with 4.0% of a Citrus Fresh fragrance containing diethyl phthalate. This mixture may then be placed into a V-blender. 1.0% of sodium lauryl sulfonate may then be added to the V-blender, followed by mixing until substantially homogeneous. 5.0% Catalase, 0.5% amorphous silica, and 0.0025% acid blue # 9 will then be added, with additional mixing until substantially homogeneous.

Ex. 1b: 80.0% sodium percarbonate, 4.0% of an Evergreen fragrance containing isopropyl myristate, 1.0% sodium alpha olefin sulfonate, 10.0% of Catalase, 0.5% amorphous silica, and 0.0025% Sandoplast Green® may be simultaneously added to a ribbon blender. The contents of the ribbon blender will undergo mixing until substantially homogeneous.

The final formulations of Examples 1a-b will be observed at room temperature for premature effervescence, and then inserted into an aqueous environment.

Variations, modifications and other implementations of what is described herein will occur to those of ordinary skill in the art without departing from the spirit and scope of the invention. Accordingly, the invention is in no way limited by the preceding illustrative description.

What is claimed is:

1. An effervescent composition comprising:
at least one solid or liquid hydrogen peroxide source;
at least one catalyst that is capable of catalyzing oxidation of the hydrogen peroxide source; and
a non-hygroscopic solvent selected from the group consisting of diethyl phthalate, isopropyl myristate, isopropyl palmitate, dioctyl adipate, and butyl stearate,
wherein the composition is capable of effervescence upon contact with a liquid and the effervescence is substantially avoided until the composition contacts said liquid.

2. The effervescent composition of claim 1, wherein the hydrogen peroxide source is a solid source selected from urea peroxide, carbamide peroxide, and inorganic perhydrate salts.

3. The effervescent composition of claim 1, wherein the catalyst is a catalase.

4. The effervescent composition of claim 1, wherein the non-hygroscopic solvent is anhydrous.

5. The effervescent composition of claim 1, wherein the non-hygroscopic solvent is non-polar.

6. The effervescent composition of claim 1, further comprising a fragrance.

7. The effervescent composition of claim 6, wherein the fragrance comprises the non-hygroscopic solvent.

8. The effervescent composition of claim 1, further comprising a colorant.

9. The effervescent composition of claim 1, further comprising a surfactant.

10. The effervescent composition of claim 1, further comprising a disinfectant.

11. The effervescent composition of claim 1, further comprising a chelating agent.

12. The effervescent composition of claim 1, further comprising an absorbing agent.

13. The effervescent composition of claim 1, wherein the ratio of the hydrogen peroxide source and the catalyst to the non-hygroscopic solvent is 9:1 or more.

14. The effervescent composition of claim 1, wherein the composition is contained within a reagent vessel capable of dissolving in water.

15. The effervescent composition of claim 14, wherein the reagent vessel is a sealed pouch.

16. A method of making an effervescent composition, comprising
mixing at least one solid or liquid hydrogen peroxide source and at least one catalyst capable of catalyzing oxidation of the hydrogen peroxide source; and
combining the mixture with a non-hygroscopic solvent selected from the group consisting of diethyl phthalate, isopropyl myristate, isopropyl palmitate, dioctyl adipate, and butyl stearate,
wherein the effervescent composition is capable of effervescence upon contact with a liquid and the effervescence is substantially avoided until the effervescent composition contacts said liquid.

17. The method of claim 16, wherein the hydrogen peroxide source is a solid source selected from urea peroxide, carbamide peroxide, and inorganic perhydrate salts.

18. The method of claim 16, wherein the catalyst is a catalase.

19. The method of claim 16, wherein the non-hygroscopic solvent is anhydrous.

20. The method of claim 16, wherein the non-hygroscopic solvent is non-polar.

21. The method of claim 16, wherein the liquid comprises water.

22. The method of claim 16, further comprising adding at least one of a fragrance, surfactant, disinfectant, chelating agent, or absorbing agent to the effervescent composition.

23. The method of claim 22, wherein the fragrance comprises the non-hygroscopic solvent.

24. The method of claim 16, wherein the composition is contained in a reagent vessel.

25. The method of claim 16, further comprising pressing the effervescent composition into tablet form.

26. The method of claim 16, wherein the ratio of the mixture to the non-hygroscopic solvent is 9:1 or greater.

27. A method for controlling effervescence in a liquid environment, comprising
introducing to a liquid environment an an effervescent composition comprising at least one solid or liquid hydrogen peroxide source and at least one catalyst capable of catalyzing oxidation of the hydrogen peroxide source, and a a non-hygroscopic solvent selected from the group consisting of diethyl phthalate, isopropyl myristate, isopropyl palmitate, dioctyl adipate, and butyl stearate;
wherein the effervescent composition is capable of effervescence upon contact with a liquid in the liquid environment and the effervescence is substantially avoided until the effervescent composition contacts said liquid.
